(19) United States
(12) Patent Application Publication
(10) Pub. No.: US 2004/0134077 A1
(43) Pub. Date: Jul. 15, 2004

(54) Hand tool and bit

(76) Inventors: Gramham John Martin, West Yorkshire (GB); George Owen Horatio Morris, Forres (GB); Andrew MacPherson Rosie, South Yorkshire (GB); Paul Howell, West Yorkshire (GB)

Correspondence Address: FISH & RICHARDSON PC, 225 FRANKLIN ST, BOSTON, MA, 02110, US

(21) Appl. No.: 10/362,346

(22) PCT Filed: Jun. 27, 2001
(86) PCT No.: PCT/GB01/02850

(30) Foreign Application Priority Data
Jun. 27, 2000 (GB) 0015629.9

(51) Int. Cl. B25D 3/00

(52) U.S. Cl. 30/167

(57) ABSTRACT

A chisel (10) comprises a handle (14), shank (12) and working bit (16). A key (80) slides longitudinally in a dovetail slot (30) and is driven by an actuator sleeve (70) which serves to draw the key (80) up the slot (30). The key (80) has a key-head (82) which engages the blade bit (16) and draws it onto a seat formed a the end of the shank (12). On the other hand, a chisel (10′) comprises a handle (14), a shank (120), and a tool bit (160), wherein the shank is a plastics moulding and the tool bit is moulded on the end of the shank. The shank and handle between them have a selectively disengageable plug (124) and socket (402).

This invention relates to hand tools and in particular to a chisel. Hand tools in general, and chisels in particular, comprise a handle, a shank, and a working bit at the end of the shank. While the shank and the handle seldom require any servicing, it is the tool bit that performs the working operation of the hand tool and which is frequently subject to wear and tear.

U.S. Pat. No. 5,953,820, EP-A-0148546 and FR-A-2570014 all disclose chisels having replaceable tool bits at the end of the shank. In U.S. Pat. No. 5,953,820, the replaceable blades are retained by screws. In EP-A-0148546, the replaceable tip is a thin razor blade which is retained by a tab on a seat at the end of the shank and a pivotable retention key riveted to the shank. In FR-A-2570014, the bit is screwed onto a threaded extension of the shank.

All of these arrangements suffer either from lack of convenience or insecurity of fixture of the bit to the tool shank. It is, therefore, an object of the present invention to provide a hand tool having a handle, a shank and a working tip on a seat at the end of the shank, wherein the bit is separable from the shank, which does not suffer from the aforementioned disadvantages, or at least mitigates their effect.

In accordance with the present invention there is provided such a hand tool wherein the bit is retained on the shank by a retention mechanism comprising a key coupled with the working bit and an actuating means at or adjacent the handle to draw the working bit coupled with the key into engagement with the seat on the shank, so that the shank and key are counter-stressed with respect to one another to securely locate the working bit on the shank. The key is preferably tensioned, so that the shank is under compression. This permits the shank to be constructed from plastics material, which is stronger under compression, whereas the key is preferably metallic.

Preferably the key slides in a slot in the shank and the actuating means comprises mutually engaging cam surfaces on the key and an actuator on the handle.

The actuator may comprise a sleeve around the handle axially fixed but rotationally free thereon, and wherein said mutually engaging cam surfaces comprise a screw thread on the sleeve and grooves on the key.

The bit may be dovetailed into the seat so that movement thereof relative to the shank is excluded when the retention mechanism is actuated.

Preferably, said seat comprises:

a flat land with a tapered edge; and,

a rear abutment shoulder on opposite side surfaces of the land;

wherein said bit comprises:

a deep groove with a tapered floor to seat on said land; and,

front shoulders on each edge of said groove to abut said rear abutment shoulders.

More preferably, said seat further comprises:

an undercut recess in one or both rear abutment shoulders; and,

wherein said bit further comprises:

a chamfered tongue on one or both edges to mate with said recesses.

Preferably, said recesses and tongues are semi-circular. The coupling between the key and bit may comprise a keyed cut-out in one of said tongues and a corresponding key-head on the key.

The key may be dovetailed into said slot. Indeed, there may be two keys and two slots, one on either side of the shank. Each tongue may have said keyed cut-out, and both keys may engage the cut-outs, one on either side of said land.

The tool may be a chisel.

In an alternative arrangement in accordance with a second aspect of the present invention, a chisel comprises a handle, a shank and a tool bit, wherein the shank is a plastics moulding and the tool bit is moulded on the end of the shank, the shank and handle between them having a selectively disengageable plug and socket, by means of which plug and socket the shank is connectable to the handle.

Thus, while the whole blade of the chisel is discarded when the tool bit is worn, most of the blade comprises inexpensive plastics material in the shank and with which the tool bit is permanently interfaced. Moreover, different from the first aspect of the present invention, the disengageable connection between the replaceable part of the chisel and the retained part is brought within the confines of the handle. One effect of this is that greater bulk of the connection can be provided here, and so that the stresses imposed in the material at the connection can be mollified. The result of this is that the shank can be constructed entirely from a material not requiring such high strength characteristics as steel. That is to say, it is this feature that permits the whole shank (other than the tool bit) to be constructed of plastics.

Preferably, the handle incorporates the socket and the shank incorporates the plug, an actuator serving to lock the plug when inserted in the socket. Preferably, the plug has a collar adapted to abut a face of the socket and through which abutment forces are transmitted between the handle and shank. Preferably the collar conforms to the shape of the handle and provides a tapering transition between the handle and shank.

Preferably, the actuator is a spring-biased lever, pivoted about an axis in the handle, said lever, in an actuated position thereof, lying flush with the surface of the handle. The lever may have a pin which, on pivoting of the lever, enters an eye of the plug, said pin lying tangential the arc of movement of the pin on pivoting of the lever.

Preferably, the plug has a sloping cam surface engaging the pin on entry of the plug in the socket and serving to pivot the lever to a non-actuated position, against said spring-bias, before said pin snaps into engagement with said eye when said collar abuts said face of the socket.

The invention is further described hereinafter, by way of example, with reference to the accompanying drawings in which:

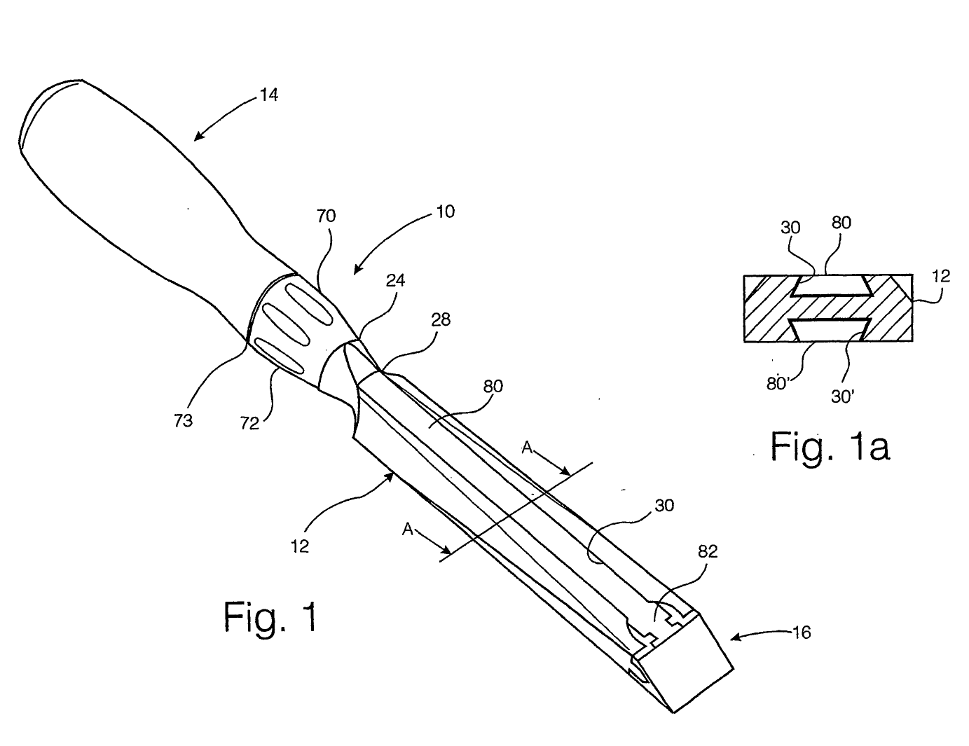

FIG. 1 is a perspective view of a chisel in accordance with the first aspect of the present invention, FIG 1a being a section of a modification of the chisel of FIG. 1 on the line A-A in FIG. 1;

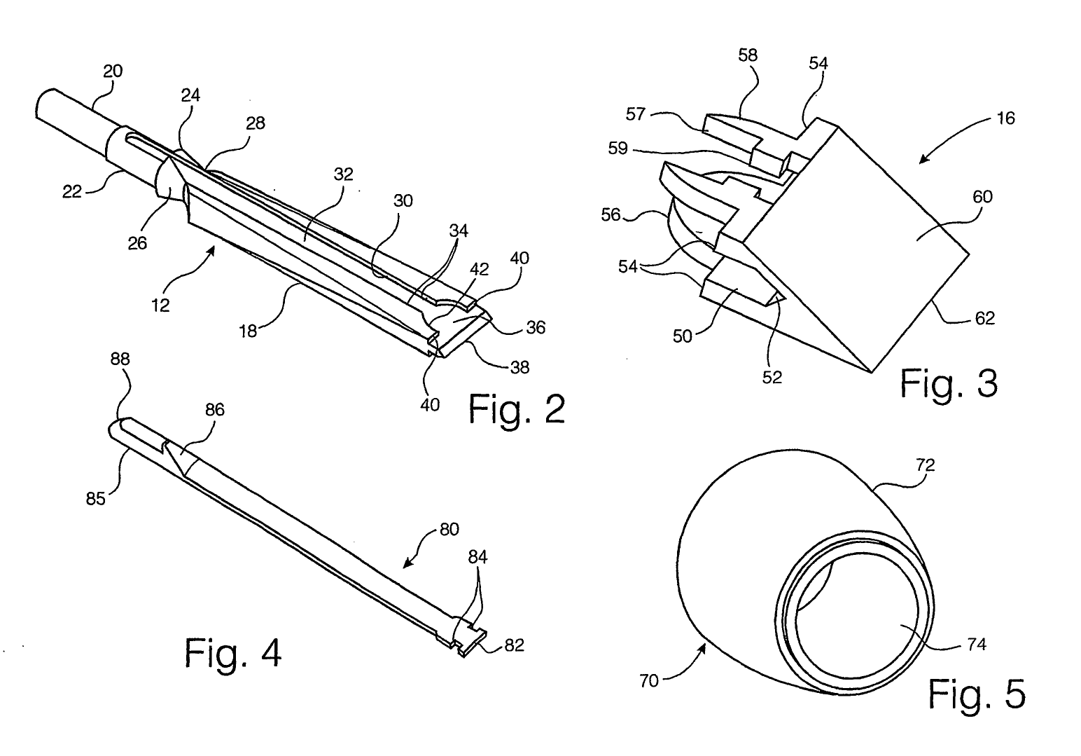

FIG. 2 is a perspective view of the shank of the chisel of FIG. 1;

FIG. 3 is a perspective view of the blade of the tool of FIG. 1;

FIG. 4 is a perspective view of the key of the tool of FIG. 1;

FIG. 5 is a perspective view of the actuator sleeve of the tool of FIG. 1;

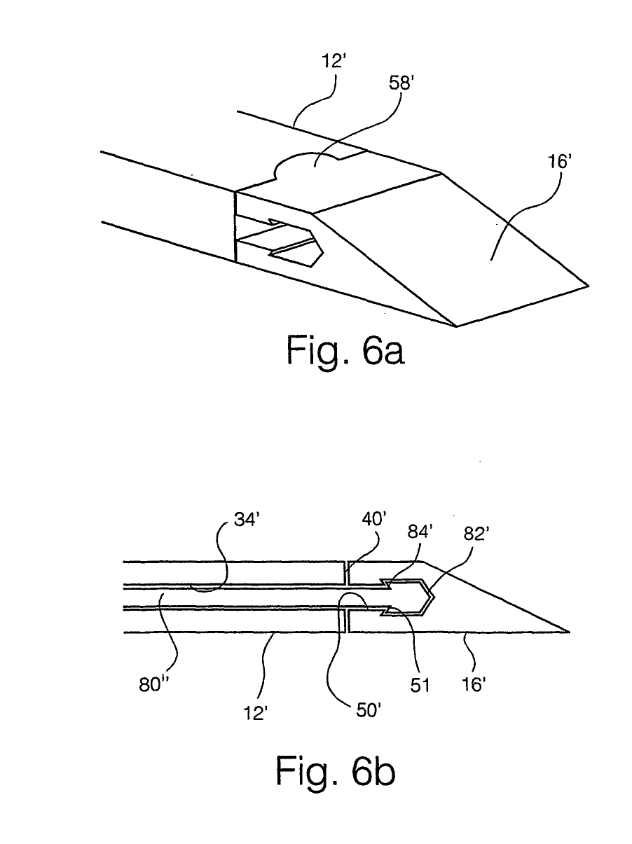

FIGS. 6a and b are respectively a perspective view and a side section through another embodiment of chisel in accordance with the first aspect of the present invention;

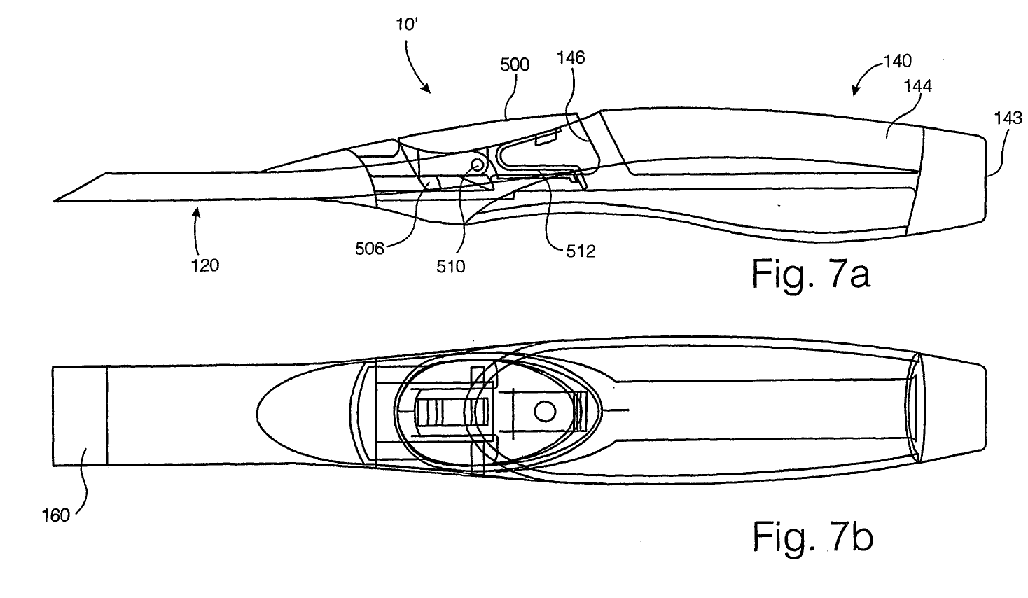

FIGS. 7a and b are respectively a side view and a plan view of a chisel in accordance with a second aspect of the present invention;

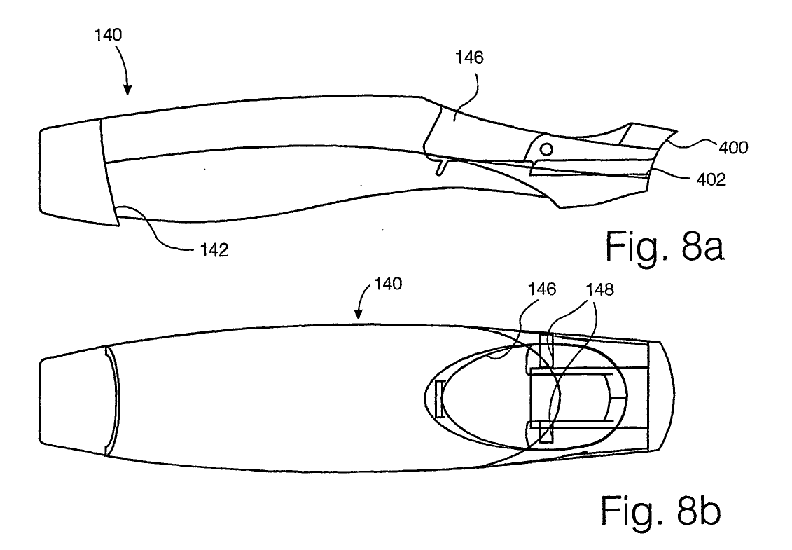

FIGS. 8a and b are respectively a side view and a plan view of the handle only of the chisel in FIG. 7;

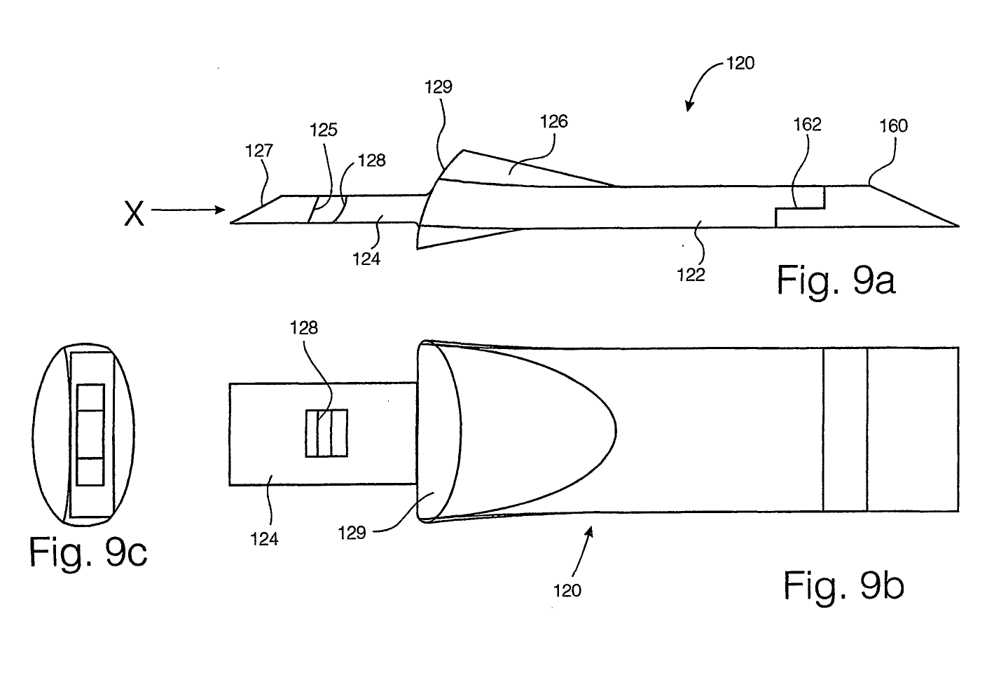

FIGS. 9a, b and c are respectively a side view, a plan view and an end view in the direction of Arrow X in FIG. 9a, of the shank and blade assembly only of the chisel in FIG. 7; and

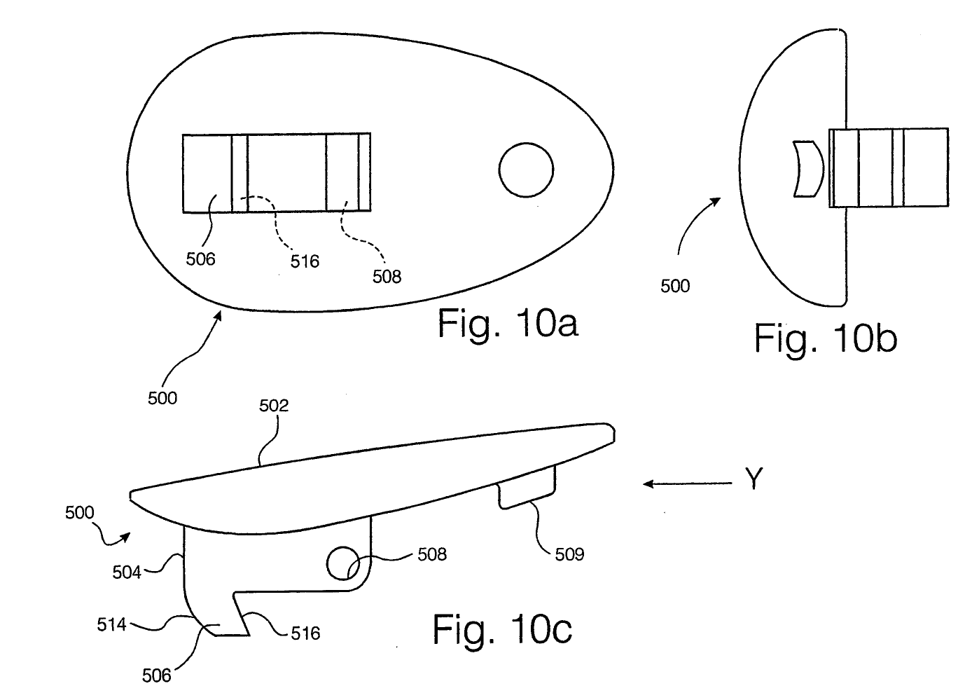

FIGS. 10a, b and c are respectively an underneath view, an end view in the direction of Arrow Y in Figure 10c, and a side view, of an actuator for use in the chisel in FIG. 7.

In FIG. 1, a chisel 10, comprises a shank 12 having connected thereto, at one end, a handle 14, and, at the other end, a blade or tool bit 16.

The shank 12 is shown in more detail in FIG. 2 and comprises a plastics moulding comprising a body 18 and a haft 20. On the haft 20 is a cylindrical bearing surface 22 which is terminated by a shoulder 24 having a chamfered face 26 terminating in a neck 28 of the chisel 10. The handle 14 is fixed on the haft 20 by any convenient means such as by ultrasonic welding or by an adhesive. A dovetail slot 30 is formed down the length of the shank 12 and is provided with a flat bed 32 and dovetailed or undercut sides 34. On the end of the shank 12 is a flat land 36 terminating in a bevelled edge 38. The land 36 is terminated by undercut shoulders 40 between which is defined a semi-circular recess 42, which is also undercut or dovetailed.

The underside of the land 36 is a mirror image of the topside.

By contrast, the blade tip 16 shown in FIG. 3 comprises a deep groove 50 terminated with a tapered floor 52. Front shoulders 54 are provided on each edge of the groove and a tongue 56, 58 is disposed centrally on each shoulder 54. The chisel bit 16 comprises a normal sloping surface 60 with a sharp working edge 62.

Returning to FIG. 1, the handle 14 captures an actuator sleeve 70 rotatably disposed on the bearing 22. The actuator sleeve 70 is captivated between the shoulder 24 and a front face 73 of the handle 14. Also visible in FIG. 1 is a key 80 which is a sliding fit in the slot 30.

In FIG. 4, the key 80 is shown in more detail and comprises a key-head 82 having notches 84 formed therein. In section, the key 80 is trapezoidal so that it is restricted only to longitudinal movement in the slot 30 being retained by the undercut side 34 of the slot 30. At its end remote from the key-head 82, the key 80 is provided with a chamfered region 86 which corresponds with the tapering face 26 of the shank 12. Behind the face 86, the end 88 of the key 80 has a cylindrical surface 85 corresponding with the cylindrical surface of the bearing 22 of the shank 12. However, instead of being a smooth bearing surface as the surface 22, the surface 85 has screw thread grooves formed on its surface which, if continued over the surface 22, would form a complete screw thread.

In FIG. 5, the actuator sleeve 70 is shown which has a shaped outer surface 72 to blend with the outer surface of the handle 14 and tapering neck region 26, 28 of the shank 12. However, it has a cylindrical internal surface 74 which is threaded with a screw thread corresponding with the screw thread on the end 88 of the key 80. Thus, when in the assembled condition as shown in FIG. 1, rotation of the actuator sleeve 70 serves to draw the key 80 up and down the groove 30.

Referring again to FIG. 3, the tool bit 16 is provided with a keyed slot 57 in the tongue 58, which slot is provided with dogs 59. The keyed slot 57 corresponds in shape to the key-head 82. Thus, when the key 80 extends beyond the end of the land 36, the key-head 82 can be engaged with the dogs 59. Then, by rotation of the actuator sleeve 70, the key is progressively drawn up the shank 12 drawing the bit 16 into engagement with the land 36 until the bevelled edge 38 thereof engages the chamfered floor 52 of the groove 50. When the actuator sleeve is tightened so that the key is placed in tension, the bit 16 is pressed into engagement with the seat of the shank 12 formed by the land surfaces 36, its front edge 38, the shoulders 40 and the recess 42.

Particularly in a chisel which is performing accurate chiselling work and being struck on the end of its handle 14 by a mallet (not shown) it is important that the connection of the working bit 16 to the remainder of the tool is secure. Thus, the surface edges of the tongues 56, 58 are chamfered so that they locate precisely with the undercut recesses 42 and prevent any tendency for the blade bit 16 to pivot about the base of floor 52 of the groove during operation of the chisel.

Indeed, as shown in the section in FIG. 1a, two keys 80, 80′ may be provided in upper and lower grooves 30, 30′ in the two main surfaces of the shank 12. This provides a particularly rigid arrangement.

In another embodiment shown in FIGS. 6a and b, the key 80″ is entirely internal of the shank 12′, which is provided with an internal bore 34′ to receive the key 80″ in an axially slidable way. Here, the head 82′ is provided with undercut barbs 84′. The tool bit 16′ is an extrusion, having a slot 50′ along its length having undercuts 51 corresponding with the barbs 84′. A similar arrangement to that described above draws the key up and down the key-way 34′, and when the head 82′ extends a long way from the shank 12′, the tool bit can be slid onto the head 82′ in a transverse direction. When the key is then drawn into the key-way 34′, the tool bit 16′ is pulled tightly against the bottom face 40′ of the shank 12′. A dimple 58′ may be provided on the tool bit to centralise the tool bit with respect to the shank 12′, which is provided with a corresponding indent in its face 40′. This embodiment has the advantage of hiding parts which move against one another so that there is less risk of clogging with dust etc.

With the arrangement proposed by the present invention, it is now feasible for not only the handle 14 to be constructed from a plastics moulding, but also for the shank 12. A rigid impact and shatter resistant plastics material such as glass reinforced nylon is suitable. The working tip 16 is necessarily made of quality steel so that the edge 62 remains sharp for a reasonable working life. Although it would be feasible to sharpen the working bit 16, as with any chisel, one of the advantages of the present invention is that it provides for quick and simple replacement of the blades 60 as required. The key 80 is likewise made of metal, and the threaded part 74, at least, of the actuator 70 is also made of metal.

While the present invention has been described with reference to a chisel, it is feasible that the chisel bit 16 may be replaced by other working bits such as scrapers or shapers of various types. Moreover, the entire tool 10 may be configured differently so as to provide for quite different applications such as in a surgical application where the tool bit 16 needs to be precisely shaped for the particular application in hand, or where a quick and convenient bit exchange is required, while nevertheless resulting in a secure location of the bit on the tool.

Turning to FIGS. 7 to 10, a chisel 10′ in accordance with the second aspect of the present invention comprises a handle 140 and shank 120. The shank 120 is separable from the handle 140 by virtue of a plug and socket inter-connection between them.

Referring first to FIG. 9, the shank 120 is shown in three different views and comprises a blade part 122, a plug 124 at one end thereof, and a collar 126. The plug 124 incorporates an eye 128 whose function is described further below. At its other end, the shank 122 is provided with a tool bit 160. The shank 122 is constructed from a rigid plastics material such as reinforced nylon and is moulded to the shape shown. The tool bit 160 may be an extruded section, although also, it may have various cut outs and/or upstanding projections so that it can be over-moulded with the shank 122 and form a secure fixing thereto. It is for this reason also that the tool tip 160 is provided with a stepped flank 162.

Turning to FIG. 8, the handle comprises a plastics moulding which, on its lower side, is provided with a recess 142 to receive an over-moulding of soft, elastomeric material to provide a soft grip for the chisel. A soft grip 144 is shown in FIG. 7a. Towards its front, a pocket 146 is provided in the handle 140, across which a pair of apertures 148 is formed. A front face 400 of the handle 140 is curved to correspond with rear face 129 (see FIG. 9a) of the shank 120. Moreover, the front face 400 is provided with an aperture 402 therein forming a socket that extends rearwardly to the base of the pocket 146.

With reference to FIG. 10c, an actuator 500 comprises a plastics moulding having an arcuate top surface 502, corresponding essentially with the handle 140. The actuator also has a depending flange 504. The flange 504 incorporates a pin 506 and an aperture 508. A spring locator 509 is also provided on the actuator 500.

Referring now to FIGS. 7a and b, in which all the components are shown assembled, the actuator 500 is pivoted in the handle 140 about an axle 510 which comprises a pin received in the apertures 148 in the handle 140 and the aperture 508 in the actuator 500. Between the actuator 500, retained on the spring retention element 509, and the floor of the pocket 146 in the handle 140, is disposed a U-shaped spring 512. This spring biases the actuator in an anti-clockwise direction as shown in FIG. 7a. When the handle is assembled, and a shank 120 is presented to the aperture 402 (forming the socket in the handle 140) the plug 124 engages a front, curved leading edge 514 of the pin 506. The plug 124 is provided with an inclined leading edge 127 which, as the plug is passed into the aperture 402, lifts the pin 506, pivoting the lever 500 about its axle 510. The pin 506 therefore rides along the top surface of the plug 127 until it coincides with the eye 128 in the plug 124 At that point, the pin snaps into engagement with the eye 128 returning the lever 500 to the position in FIG. 7a.

It is to be noted that rear surface 516 of the pin 506 is substantially tangential to the arc of movement of the pin 506 about the axle 510. This ensures that there is little or no free play. In fact, front surface 125 of the eye 128 is inclined a different angle to the face 516. Clockwise pivoting of the lever 500 therefore presses the face 516 against the wall 125 of the eye 128. This draws the plug 124 into the pocket 146 and thereby closely engages the face 128 of the collar 126 with the face 400 of the handle 140. All free play is therefore taken up and a secure connection between the blade and handle is effected.

When the chisel is employed in its conventional fashion (for example by striking the rear end 143 of the handle 140 with a mallet), the enlarged and curved surface 400 at the end of the handle, and forming the interface with the correspondingly shaped collar 126 on the shank 120, spreads the transfer of the impact into the shank 120. Therefore, stresses on the connection between the shank and the handle are minimised. Given the permanence of the connection of the tool bit 160 to the shank 120 there is no likelihood of those components coming apart.

Because the shank is primarily plastics material, it is inexpensive to manufacture. Therefore replacement shanks, having new and sharp tool bits 160 at their ends, can easily be provided. Indeed, the size of the shank (that is to say its width) has no relation to the inter-connection between it and the handle or the size of the handle.

It is therefore proposed that a kit might be provided comprising a single handle 140 and a number of shanks 120 of different widths. The shanks could be provided in a cassette with the plugs 124 of each shank presented in a position ready for attachment a handle 140. Indeed, each shank 120 may be clipped into the cassette so that each shank is retained in the cassette against falling-out during transportation of the cassette. The clip may be arranged so that, as a handle 140 is slid over the plug 124, the clip is disengaged. This releases the shank 120 from the cassette and so that, when the pin 506 snaps into engagement with the eye 128, the assembled chisel 10 can be withdrawn from the cassette. The cassette might have mounting means to enable mounting on a work bench or against a wall.

1. A hand tool having a handle, a shank and a working bit on seat at the end of the shank, wherein the bit is separable from the shank and is retained thereon by a retention mechanism comprising a key coupled with the working bit and an actuating means at or adjacent the handle to draw the working bit coupled with the key into engagement with the seat on the shank, so that the shank and key are counter-stressed with respect to one another to securely locate the working bit on the shank.

2. A hand tool as claimed in claim 1, wherein the key is tensioned.

3. A hand tool as claimed in claim 1 or 2, wherein the key slides in a slot in the shank and the actuating means comprises mutually engaging cam surfaces on the key and an actuator on the handle.

4. A hand tool as claimed in claim 3, wherein the actuator comprises a sleeve around the handle axially fixed thereon, but is rotationally free.

5. A hand tool as claimed in claim 4, wherein said mutually engaging cam surfaces comprise a screw-thread on the sleeve and grooves on the key.

6. A hand tool as claimed in any preceding claim, wherein the bit is dovetailed into the seat so that movement thereof relative to the shank is excluded when the retention mechanism is actuated.

7. A hand tool as claimed in claim 6,
wherein said seat comprises:
a flat land with a tapered edge; and
a rear abutment shoulder on opposite side surfaces of the land; and
wherein said bit comprises:
a deep groove with a tapered floor to seat on said land; and
front shoulders on each edge of the said groove to abut said rear abutment shoulders.

8. A hand tool as claimed in claim 7, wherein said seat further comprises:
an under-cut recess in one or both rear abutment shoulders, and
wherein said bit further comprises:
a chamfered tongue on each edge to mate with said recesses.

9. A hand tool as claimed in claim 8, wherein said recesses and tongues are semi-circular.

10. A hand tool as claimed in claim 8 or 9, wherein said coupling between the key and bit comprises a keyed cut-out in one of said tongues and a corresponding key-head on the key.

11. A hand tool as claimed in claim 3, or in any of claims 4 to 10 when dependent on claim 3, wherein the key is dovetailed into said slot.

12. A hand tool as claimed in any preceding claim, wherein there are two keys and two slots, one on either side of the shank.

13. A hand tool as claimed in claims 10 and 12, wherein each tongue has said keyed cut-out and both keys engage the cut-outs one on either side of said land.

14. A hand tool as claimed in any preceding claim, wherein said shank is constructed from plastics material.

15. A hand tool as claimed in any preceding claim, wherein the tool is a chisel.

16. A chisel comprising a handle, a shank and a tool bit, wherein the shank is a plastics moulding and the tool bit is moulded on the end of the shank, the shank and handle between them having a selectively disengageable plug and socket, by means of which plug and socket the shank is connectible to the handle.

17. A chisel as claimed in claim 16, in which the handle incorporates the socket and the shank incorporates the plug, an actuator serving to lock the plug when inserted in the socket.

18. A chisel as claimed in claim 17, in which the actuator is a spring-biased lever, pivoted about an axis in the handle, said lever, in an actuated position thereof, lying flush with the surface of the handle.

19. A chisel as claimed in claim 18, in which the lever has a pin which, on pivoting of the lever, enters an eye of the plug, said pin lying tangential the arc of movement of the pin on pivoting of the lever.

20. A chisel as claimed in claim 19, in which the plug has a sloping cam surface engaging the pin on entry of the plug in the socket and serving to pivot the lever to a non-actuated position, against said spring-bias, before said pin snaps into engagement with said eye when said collar abuts said face of the socket.

21. A chisel as claimed in claim 18, 19 or 20, in which the handle is a plastics moulding having a pocket in which said lever is pivoted, said socket opening into the floor of said pocket.

22. A chisel as claimed in any of claims 16 to 21, in which the plug has a collar adapted to abut a face of the socket and through which abutment forces are transmitted between the handle and shank.

23. A chisel as claimed in claim 22, in which the faces of the socket and abutting collar are curved being convex towards the tool bit so as to concentrate forces through the handle into the shank and tool bit.

24. A chisel as claimed in claim 22 or 23, in which the collar conforms to the shape of the handle and provides a tapering transition between the handle and shank.

25. A kit comprising a cassette to retain a plurality of shanks and a handle to which one of said shanks may be connected to form a chisel as claimed in any of claims 16 to 24.

26. A kit as claimed in claim 25, in which said tool bits of the shanks are each of a different size.

27. A kit as claimed in claim 25 or 26, in which each shank is clipped into the cassette and is released therefrom on engagement of said plug and socket.

28. A chisel substantially as hereinbefore described with reference to FIGS. 1 to 5, 6, or 7 to 10 of the accompanying drawings.
